(19) United States
(12) Patent Application Publication
(10) Pub. No.: US 2006/0238910 A1
(43) Pub. Date: Oct. 26, 2006

(54) Recording and/or reproducing device having an ejection amount adjustment mechanism capable of changing ejection amount in a software fashion

(75) Inventors: Kouji Kobayashi, Kanagawa (JP); Nobutaka Tsuneyoshi, Kanagawa (JP); Hiromi Inoguchi, Kanagawa (JP); Naoki Tatsumi, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 11/343,660

(22) Filed: Jan. 31, 2006

(30) Foreign Application Priority Data
Apr. 22, 2005 (JP) 2005-125467

(51) Int. Cl. G11B 19/02

(52) U.S. Cl. 360/69

(57) ABSTRACT

An ejection position detection mechanism has an arc-shaped plate, attached to a mode gear, having a plurality of detected elements provided at positions corresponding to a plurality of ejection positions of a cartridge, and a detection arrangement, disposed near to the arc-shaped plate, for detecting the plurality of detected elements. The arc-shaped plate consists of a shielding plate. The plurality of detected elements consist of an edge of the shielding plate and two slits formed on the shielding plate. The detecting arrangement consists of a photo-interrupter.

This application claims priority to prior Japanese Patent Application JP 2005-125467, the disclosure of which is incorporated herein by reference.

### BACKGROUND OF THE INVENTION

This invention relates to a recording and/or reproducing device represented by DLT (digital linear tape) or LTO (linear tape open) and, in particular, to an ejection mechanism for ejecting a cartridge out of the recording and/or reproducing device.

Recording and/or reproducing devices of the type described are developed for use in back-up ones of computer systems and various types of the recording and/or reproducing devices have been proposed in prior art. Such a recording and/or reproducing device serving as the LTO is disclosed, for example, in U.S. Pat. No. 6,322,014 issued to Robert Nemeth.

The recording and/or reproducing device may be also a tape drive in which a cartridge having a single reel (a supply reel) can be installed. The cartridge may be also called a cassette. The recording and/or reproducing device contains a take-up reel therein. When the cartridge is installed in the recording and/or reproducing device, a magnetic tape is pulled out of the cartridge and then is wound by the take-up reel through a tape-transport path. The tape-transport path is for guiding the magnetic tape pulled out of the cartridge in a magnetic head. The magnetic head exchanges information between the tape and the magnetic head. In addition, the take-up reel is rotationally drivable by means of a real motor.

For holding the cartridge, the tape drive has holder means which hereinafter referred to as a lift. The lift is movable between a loading position and an operating position. The lift is moved along an L-shaped path of movement. That is, the lift first be moved from its loading position into its operating position in the direction insertion and, subsequently, in a direction towards a chassis perpendicularly to the direction of insertion.

In order to obtain this direction of movement, the tape drive has guide means including a first guide wall and a second guide wall. The two guide walls have guide channel slots or guide channels, which are engaged by guide pins which project laterally from the lift.

The tape drive has actuating means for moving the lift. The actuating means include two actuating slides which are guided so as to slidable parallel to the direction of insertion. The two actuating slides are each connected to a gear rack. Each of the actuating slides has a cam surface which is inclined with respect to the plane of the chassis, which each cooperates with a cam follower which projects laterally from the lift. As a result, the lift is movable by moving the actuating slides.

Now, when the cartridge is inserted in the tape drive and when information exchange between the magnetic head and the magnetic tape pulled out of the cartridge completes, the magnetic tape is rewound in the cartridge again. Thereafter, when an operator operates an ejection bottom in order to eject the cartridge from the tape drive, the cartridge is ejected from the tape drive by an ejection mechanism. In a conventional tape drive, a cartridge's projection amount (or an ejection amount) on ejecting the cartridge is usually designed at a fixed value due to the ejection mechanism. The ejection amount means a projection amount measured with reference to a bezel on ejecting.

On the other hand, a popular device for handling large amounts of information in a data processing system is an automated autoloader/library system. Such an automated autoloader/library system is disclosed, for example, in U.S. Pat. No. 6,816,331 issued to Ryan Stuart Porter et al. The autoloader/library system is a complete tape cartridge library that stores, manages, and automatically exchanges a plurality of cartridges between the tape drive, a single cartridge interface, and tape cartridge transport magazines. The autoloader/library system comprises a cartridge picker. If a read/write operation is desired, the cartridge picker provides the selected cartridge to the tape drive. If an ejection operation is desired, the cartridge picker provides the selected cartridge to the single cartridge interface for retrieval by an operator. If a load balancing operation is desired, the cartridge picker exchanges the cartridge between one tape cartridge transport magazine and another tape cartridge transport magazine.

Such autoloader/library systems are manufactured in different specifications by autoloader makers. For the purpose, on mounting tape drives on the autoloader/library system, different ejection amounts may be required to the autoloader makers.

Accordingly, as a first workaround for this problem, a maker for manufacturing the tape drives makes parts for the ejection mechanism for the specification of the ejection amount. However, the first workaround is disadvantageous in that it drives up costs because it must make a plurality of parts for the ejection mechanism.

In addition, as a second workaround for this problem, an ejection mechanism capable of varying and adjusting the ejection amount is known, for example, in U.S. Pat. No. 6,710,970 issued to Ikuichiro Nawa. According to Nawa, the ejection mechanism is mounted on one side surface of a tape drive in order to eject a cartridge from the tape drive. A damping member for braking movement of an ejection lever by engaging with the ejection lever has a stopper for stopping the movement of the ejection lever. A mounting position of the damping member to the one side surface is adjusted by a mounting adjusting arrangement. When the cartridge is inserted in the tape drive, the ejection lever having an engaging portion for engaging with a front end surface of the cartridge is urged in an ejection direction by an ejection spring. That is, in the ejection mechanism according to Nawa, by adjusting the mounting position of the damping member by the mounting adjusting arrangement, adjustment of the ejection amount is supported in a hardware fashion. However, the second workaround is disadvantageous in that there is a possibility of causing an assembly error because the second workaround must assemble the ejection mechanism in the hardware fashion.

### SUMMARY OF THE INVENTION

It is therefore an object of the present invention to provide a recording and/or reproducing device, an ejection mechanism, an ejection amount adjustment mechanism, and an ejection position detection mechanism wherein it is unnecessary to replace parts for the ejection mechanism used in each autoloader maker.

It is another object of the present invention to provide a recording and/or reproducing device, an ejection mechanism, an ejection amount adjustment mechanism, and an ejection position detection mechanism which are capable of adjusting an ejection amount in a software fashion.

It is still another object of the present invention to a recording and/or reproducing device, an ejection mechanism, an ejection amount adjustment mechanism, and an ejection position detection mechanism wherein it is unnecessary to add a particular part in order to support a plurality of ejection amounts.

Other objects of this invention will become clear as the description proceeds.

On describing the gist of a first aspect of this invention, it is possible to be understood that a recording and/or reproducing device comprises an ejection mechanism for ejecting a cartridge accommodated in the recording and/or reproducing device out of the recording and/or reproduction device by coming into contact with the cartridge. According to the first aspect of this invention, the ejection mechanism comprises an ejection amount adjustment mechanism for adjusting an ejection amount of the cartridge by rewriting firmware without replacing any part.

In the above-mentioned recording and/or reproducing device, the ejection mechanism, for example, may comprise a mode motor, a mode gear driven by the mode motor, and a cartridge holder, coupled to the mode gear, for holding the cartridge. In this event, the ejection amount adjustment mechanism, for example, may comprise an arc-shaped plate, attached to the mode gear, having a plurality of detected elements provided at positions corresponding to a plurality of ejection positions of the cartridge, a detection arrangement, disposed near to the arc-shaped plate, for detecting the plurality of detected elements to produce a plurality of detected signals, and a control circuit for stopping driving of the mode motor on the basis of one selected from the plurality of detected signals. The arc-shaped plate may comprise a shielding plate and the plurality of detected elements may comprise an edge of the shielding plate and at least one slit formed on the shielding plate. In this event, the detecting arrangement may comprise a photo-interrupter.

On describing the gist of a second aspect of this invention, it is possible to be understood that an ejection mechanism is for ejecting a cartridge accommodated in a recording and/or reproducing device out of the recording and/or reproduction device by coming into contact with the cartridge. According to the second aspect of this invention, the ejection mechanism comprises an ejection amount adjustment mechanism for adjusting an ejection amount of the cartridge by rewriting firmware without replacing any part.

In the above-mentioned ejection mechanism, the ejection mechanism, for example, may comprise a mode motor, a mode gear driven by the mode motor, and a cartridge holder, coupled to the mode gear, for holding the cartridge. In this event, the ejection amount adjustment mechanism, for example, may comprise an arc-shaped plate, attached to the mode gear, having a plurality of detected elements provided at positions corresponding to a plurality of ejection positions of the cartridge, a detection arrangement, disposed near to the arc-shaped plate, for detecting the plurality of detected elements to produce a plurality of detected signals, and a control circuit for stopping driving of the mode motor on the basis of one selected from the plurality of detected signals. In addition, the arc-shaped plate may comprise a shielding plate and the plurality of detected elements may comprise an edge of the shielding plate and at least one slit formed on the shielding plate. In this event, the detecting arrangement may comprise a photo-interrupter.

On describing the gist of a third aspect of this invention, it is possible to be understood that an ejection amount adjustment mechanism is provided in an ejection mechanism for ejecting a cartridge accommodated in a recording and/or reproducing device out of the recording and/or reproduction device by coming into contact with the cartridge. The ejection amount adjustment mechanism is for adjusting an ejection amount of the cartridge. According to the third aspect of this invention, the ejection amount adjustment mechanism adjusts the ejection amount by rewriting firmware without replacing any part.

In the above-mentioned ejection amount adjustment mechanism, the ejection mechanism, for example, may comprise a mode motor, a mode gear driven by the mode motor, and a cartridge holder, coupled to the mode gear, for holding the cartridge. In this event, the ejection amount adjustment mechanism, for example, may comprise an arc-shaped plate, attached to the mode gear, having a plurality of detected elements provided at positions corresponding to a plurality of ejection positions of the cartridge, a detection arrangement, disposed near to the arc-shaped plate, for detecting the plurality of detected elements to produce a plurality of detected signals, and a control circuit for stopping driving of the mode motor on the basis of one selected from the plurality of detected signals. In addition, the arc-shaped plate may comprise a shielding plate and the plurality of detected elements may comprise an edge of the shielding plate and at least one slit formed on the shielding plate. In this event, the detecting arrangement may comprise a photo-interrupter.

On describing the gist of a fourth aspect of this invention, it is possible to be understood that an ejection position detection mechanism is for use in an ejection mechanism for ejecting a cartridge accommodated in a recording and/or reproducing device out of the recording and/or reproduction device by coming into contact with the cartridge. The ejection position detection mechanism is for detecting an ejection position of said cartridge. The ejection mechanism comprises a mode motor, a mode gear driven by the mode motor, and a cartridge holder, coupled to the mode gear, for holding the cartridge. According to the fourth aspect of this invention, the ejection position detection mechanism comprises an arc-shaped plate, attached to the mode gear, having a plurality of detected elements provided at positions corresponding to a plurality of ejection positions of the cartridge, and a detection arrangement, disposed near to the arc-shaped plate, for detecting the plurality of detected elements.

In the above-mentioned ejection position detection mechanism, the arc-shaped plate may comprise a shielding plate and the plurality of detected elements may comprise an edge of the shielding plate and at least one slit formed on the shielding plate. In this event, the detecting arrangement may comprise a photo-interrupter.

### BRIEF DESCRIPTION OF THE DRAWING

FIG. 1 is a perspective view showing a tape drive serving as a recording and/or reproducing device to which this invention is applicable with an upper cover removed therefrom seen from an upper surface thereof;

FIG. 2 is a perspective view showing the tape drive illustrated in FIG. 1 seen from a lower surface thereof;

FIG. 3 is a perspective view showing a sensor board for use in the tape drive illustrated in FIG. 2;

FIG. 4 is a perspective view showing a mode gear for use in the tape drive illustrated in FIG. 2;

FIG. 5 is a perspective view showing a conventional mode gear;

FIG. 6 is a block diagram of a control system comprising a control circuit, a mode motor, and first through fourth switches for use in the tape drive illustrated in FIGS. 1 and 2;

FIG. 7A is a plan view of a main portion of the tape drive in a state before loading a cartridge;

FIG. 7B is a plan view of the main portion of the tape drive in a state after loading the cartridge;

FIGS. 8A-8G show a time chart for use in describing operation in a case of loading the cartridge;

FIG. 9 is a flow chart for use in describing operation in the control circuit in a case of loading the cartridge;

FIG. 10 is a perspective view showing the tape drive illustrated in FIG. 1 in a state where the cartridge is inserted therein;

FIG. 11 is cross-sectional view taken on line XI-XI of FIG. 10;

FIGS. 12A-12G shows a time chart for use in describing operation in a case of ejecting the cartridge;

FIG. 13 is a flow chart for use in describing operation in the control circuit in a case of ejecting the cartridge;

FIG. 14 is a perspective view showing the tape drive illustrated in FIG. 1 in a state where the cartridge is inserted therein;

FIG. 15 is a cross-sectional view taken on line XV-XV of FIG. 14;

FIG. 16 is a perspective view showing the tape drive in a state where the cartridge is stopped when the first switch reaches a position corresponding to one edge of a first shielding plate;

FIG. 17 is a perspective view showing the tape drive in a state where the cartridge is stopped when the first switch reaches a position corresponding to a trailing edge of a first slit of the first shielding plate; and

FIG. 18 is a perspective view showing the tape drive in a state where the cartridge is stopped when the first switch reaches a position corresponding to a trailing edge of a second slit of the first shielding plate.

### DESCRIPTION OF THE PREFERRED EMBODIMENTS

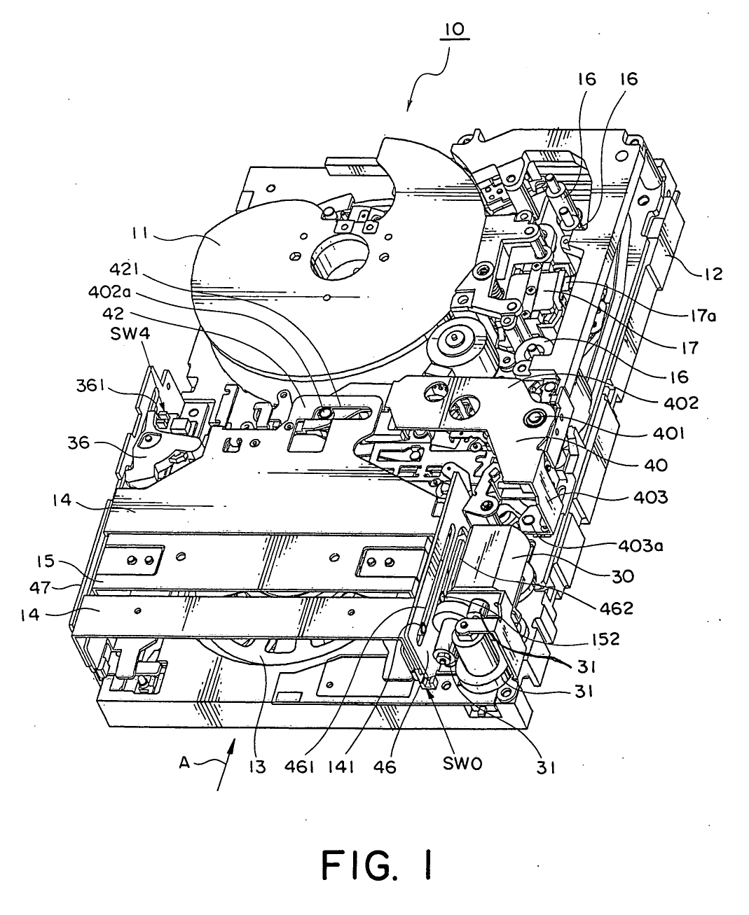

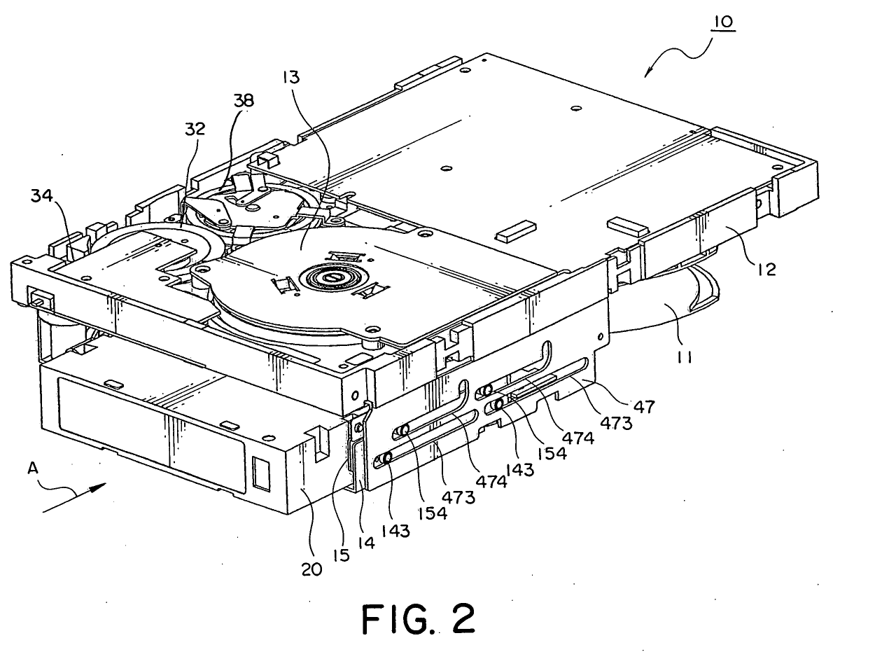

Referring to FIGS. 1 and 2, the description will proceed to a tape drive 10 serving as a recording and/or reproducing device to which this invention is applicable. FIG. 1 is a perspective view showing the tape drive 10 with an upper cover removed therefrom seen from an upper surface side. FIG. 2 is a perspective view showing the tape drive 10 illustrated in FIG. 1 seen from a lower surface side.

The tape drive 10 is for receiving a cartridge 20 and contains a take-up reel 11 inside thereof. The take-up reel 11 is also called a spool. The tape drive 10 is generally comprised of a rectangular housing (chassis) 12 that has a common base. The base has a first spindle motor (reel motor) (not shown) and a second spindle motor (reel motor) 13. The first spindle motor has the spool (or the take-up reel) 11 permanently mounted on the base of the housing 12 and the spool 11 is dimensioned to accept a relatively high speed streaming magnetic tape (which will later be described). The second spindle motor (reel motor) 13 is adapted to accept the removable cartridge 20. The removable cartridge 20 is inserted into the tape drive 10 via a cartridge holder 14 formed on the housing 12 of the tape drive 10 along an insertion direction depicted at an arrow A.

Upon insertion of the cartridge 20 into the cartridge holder 14, the cartridge 20 first is engaged in a cartridge holding mechanism 15, is automatically loaded in the tape drive 10, and then the cartridge 20 engages the second spindle motor (the supply reel motor) 13 in the manner which will later be described. Prior to rotation of the first and the second spindle motors (reel motors), the cartridge 20 is connected to the permanently mounted spool (the take-up reel) 11 by means of a connection between a grabber (not shown) and a leader pin (not shown). A number of rollers (guide rollers) 16 positioned intermediate the cartridge 20 and the permanent spool 11 guide the magnetic tape as it traverses at relatively high speeds back and forth between the cartridge 20 and the permanently mounted spool 11.

The tape drive 10 further comprises a head actuator assembly 17 having a magnetic head 17a. The head actuator 17 is located between the take-up spool 11 and the cartridge 20 on a tape-transport path (not shown) defined by the above-mentioned plurality of rollers 16. During operation, the magnetic tape flows forward and backward between the take-up spool 11 and the cartridge 20 and is closely adjacent to the head actuator 17 while the magnetic tape flows on the defined tape-transport path.

The tape drive 10 has a zeroth switch SW0 provided on a main surface of the chassis 12 at a front and right-hand side thereof. The zeroth switch SW0 is for detecting a position at which an automatic loading starts after the cartridge 20 is inserted in the cartridge holder 14. The zeroth switch SW0 comprises a photo-interrupter. The cartridge holder 14 comprises a zeroth shielding plate for shielding the zeroth switch SW0 in the manner which will later be described.

The tape drive 10 comprises a mode motor 30 mounted on the main surface of the chassis 12. The mode motor 30 is coupled via seven reduction gears 31 (only three reduction gears are illustrated in FIG. 1) to a mode gear 32 provided in a rear surface side of the chassis 12. In the rear surface side of the chassis 12, a sensor board 34 is provided opposite to the mode gear 32. At any rate, the mode gear 32 is driven by the mode motor 30.

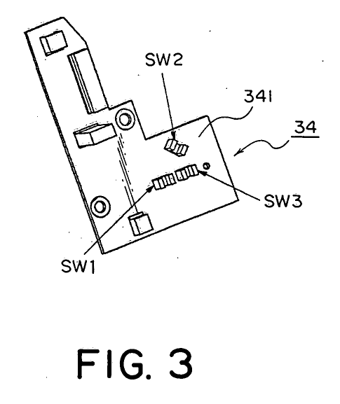

As shown in FIG. 3, the sensor board 34 comprises a sensor 341 disposed opposite to the mode gear 32. The sensor 341 consists of first through third switches SW1, SW2, and SW3. Each of the first through the third switches SW1 to SW3 comprises a photo-interrupter.

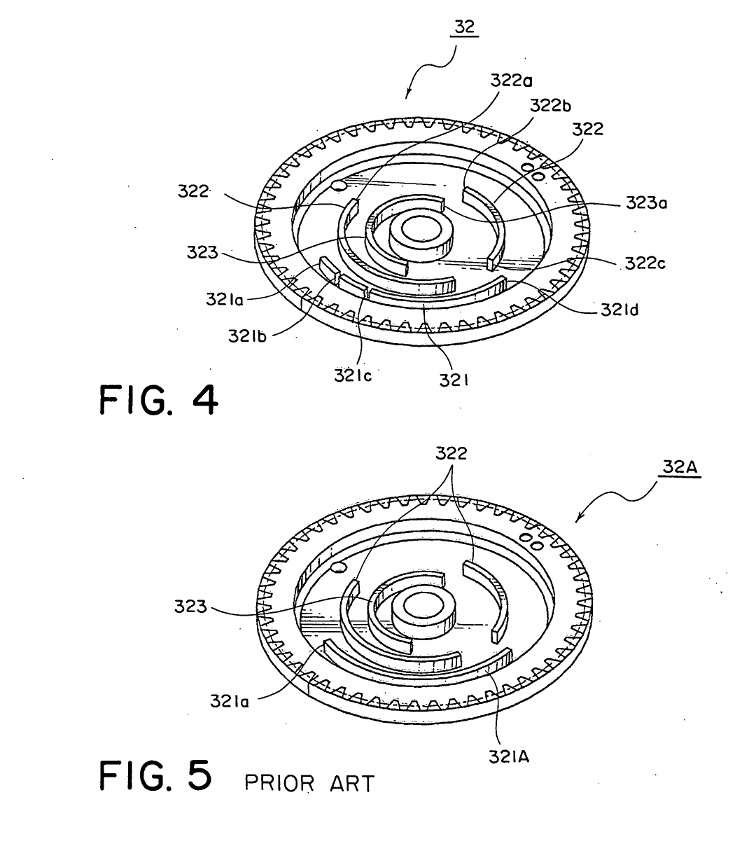

Referring to FIG. 4, the mode gear 32 comprises arc-shaped first through third shielding plates 321, 322, and 333 which are disposed opposite to the sensor board 34. The first through the third shielding plates 321 to 333 are for shielding the above-mentioned first through third switches SW1 to SW3, respectively. As shown in FIG. 4, the second shielding plate 322 consists of two shielding plates which are apart from each other.

The first switch SW1 is for detecting ejection positions of the cartridge 20 and a leader pin checking position. The second switch SW2 is for detecting a cleaning position for cleaning the magnetic head 17a, a grabber hooking position, and a grabber releasing position. The third switch SW3 is for detecting a grabber chucking position.

As shown in FIG. 4, the first shielding plate 321 has one edge 321a, a first slit 321b near to the edge 321a, and a second slit 321c near to the first slit 321b. The edge 321a, the first slit 321b, and the second slit 321c are for detecting ejection positions of the cartridge 20 in the manner which will later be described.

Although the two slits 321b and 321c are formed in the first shielding plate 321 in the example being illustrated, at least one slit may be formed in the first shielding plate 321.

For reference purposes, a conventional mode gear 32A is illustrated in FIG. 5. The conventional mode gear 32A is similar in structure to the mode gear 32 except that structure of the first shielding plate is different from that illustrated in FIG. 4 in the manner which will later be described. The first shielding plate is therefore depicted at 321A. Ones having functions similar to those illustrated in FIG. 4 are depicted at the same reference symbols, description thereof will be omitted in order to simplify the description.

The conventional fist shielding plate 321A does not have the first and the second slits 321b and 321c which are formed in the first shielding plate 321 illustrated in FIG. 4. Accordingly, in a conventional tape drive, an ejection position of the cartridge 20 is determined by only one position corresponding to the edge 321a of the first shielding plate 321A.

On the other hand, in the tape drive 10 comprising the mode gear 32 illustrated in FIG. 4, the ejection position of the cartridge 20 can be determined by selecting one from three positions which correspond to the edge 321a of the first shielding plate 321, the first slit 321b, and the second slit 321c. A change of the selection can be easily carried out by rewriting firmware. In other words, it is possible to change the ejection amount of the cartridge 30 in a software fashion.

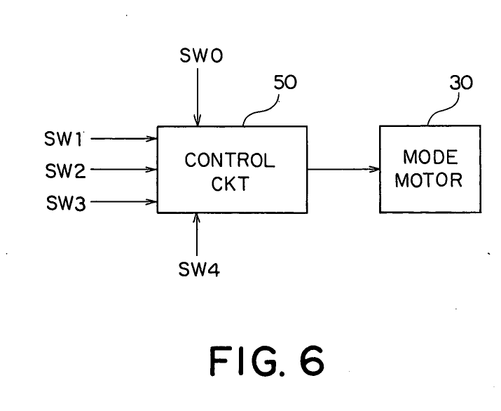

That is, in the illustrated embodiment, the ejection mechanism comprises, as a plurality of detected elements, the edge 321a, the first slit 321b, and the second slit 321c. In addition, the first switch SW1 serves as a detection arrangement, disposed near to the arc-shaped first shielding plate 321, for detecting the plurality of detected elements to produce a plurality of detected signals. In the manner which will later be described, a control circuit 50 shown in FIG. 6 stops driving of the mode motor 30 on the basis of one selected from the plurality of detected signals. That is, a combination of the arc-shaped plate 321 having the plurality of detected elements 321a, 321b, and 321c, the detection arrangement SW1, and the control circuit 50 serves as an ejection amount adjustment mechanism for adjusting the ejection amount of the cartridge 20. In addition, a combination of the arc-shaped plate 321 having the plurality of detected elements 321a, 321b, and 321c, and the detection arrangement SW1 acts as an ejection position detection mechanism for detecting an ejection position of the cartridge 20.

As shown in FIG. 1, the tape drive 10 has a fourth switch SW4 for detecting that the cartridge 20 is correctly accommodated (or inserted) in the cartridge holder 14. The fourth switch SW4 also comprises a photo-interrupter. The tape drive 10 comprises a cartridge holder locking mechanism 36 for locking the cartridge holder 14. The cartridge holder locking mechanism 36 is for preventing the cartridge holder 14 from moving in the insertion direction A when the cartridge 20 is not correctly inserted in the cartridge holder 14. Accordingly, when the cartridge 20 is correctly inserted in the cartridge holder 14, a lock of the cartridge holder 14 by the cartridge holder locking mechanism 36 is released and it results in allowing the cartridge holder 14 to move in the insertion direction A. The cartridge holder locking mechanism 36 comprises a fourth shielding plate 361 for shielding the fourth switch SW4.

As shown in FIG. 2, the tape drive 10 comprises a gear cam 38 engaged with the mode gear 32. The gear cam 38 is also called a cam gear. The gear cam 38 has a cam groove which will be later described.

As shown in FIG. 1, the tape drive 10 comprises an arm housing 40 which is rotatably disposed on the main surface of the chassis 12 around a rotation shaft 401. The arm housing 40 comprises a horizontal arm 402 extending in a horizontal direction and a vertical arm 403 extending in a vertical direction. The horizontal arm 402 has a tip in which an engagement pin 402a is provided. The vertical arm 403 has a lower end in which an engagement pin 403a is provided. The engagement pin 403a engages with the above-mentioned cam groove of the gear cam 38.

In addition, the tape drive 10 comprises a cam slider 42 which is integrally formed to the cartridge holder 14. The cam slider 42 has a slider slit 421 extending in a direction perpendicular to the insertion direction A. In the slider slit 421, the engagement pin 402a of the horizontal arm 402 of the above-mentioned arm housing 40 is inserted.

Accordingly, the cartridge holder 14 for holding the cartridge 20 is coupled to the mode gear 32 through the cam slider 42, the arm housing 40, and the gear cam 38. In the manner which will later be described, a combination of the mode motor 30, the mode gear 32, and the cartridge holder 14 serves as the ejection mechanism for ejecting the cartridge 20 accommodated in the tape drive 10 out of the tape drive 10 by coming into contact with the cartridge 20.

When the cartridge 20 is inserted in the cartridge holder 14, the cartridge 20 is held in the cartridge holder 14 through the cartridge holding mechanism 15. When the cartridge 20 is perfectly held in the cartridge holder 14, the cartridge 20 is engaged with the cartridge holding mechanism 15.

In addition, the cartridge holder 14 is only movable along the insertion direction A by a guide arrangement which will later be described. The cartridge holding mechanism 15 is movable along an L-shaped pass of movement by the guide arrangement.

With this structure, when the cartridge holder 14 moves in the insertion direction A by manually inserting the cartridge 20 in the cartridge holder 14, the arm housing 40 rotates around the rotation shaft 401 in a clockwise direction. As a result, inasmuch as the gear cam 38 rotates around a center axis thereof, the mode gear 32 engaged with the gear cam 38 also rotates around a center axis thereof. This operation is a manual load operation. However, in a case where the tape drive 10 is mounted in the above-mentioned autoloader/library system, it is noted that an insertion of the cartridge 20 in the cartridge holder 14 is automatically carried out by the autoloader/library system.

On the other hand, the mode gear 32 and the mode motor 30 are coupled to each other via the seven reduction gears 31. Accordingly, if the mode motor 30 rotates in a predetermined direction, the mode gear 32 rotates in the predetermined direction. Therefore, engaged with the mode gear 32, the cam gear 38 also rotates in the predetermined direction. As a result, the arm housing 40 having the engagement pin 403a, which is engaged with the cam groove of the gear cam 38, rotates around the rotation shaft 401 in the clockwise direction. Therefore, when the cartridge holder 14 moves in the insertion direction A, engaged with the cartridge holding mechanism 15, the cartridge 20 also moves in the insertion direction A. This operation is an automatic load operation.

A switching between the manual load operation and the automatic load operation is carried out by turning on/off of the zeroth switch SW0 in the manner which will later be described.

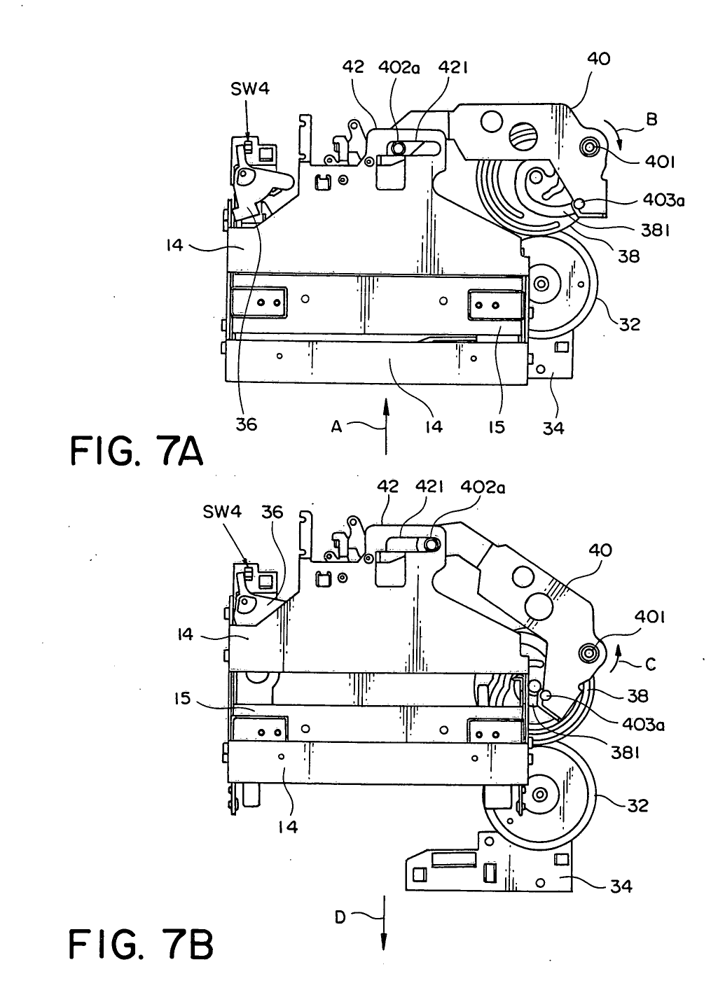

Referring now to FIGS. 7A and 7B, the description will be briefly made about an operation in a case of loading the cartridge 20. FIG. 7A is a plan view of a main portion of the tape drive 10 in a state before loading the cartridge 20. FIG. 7B is a plan view of the main portion of the tape drive 10 in a state after loading the cartridge 20.

In the manner which is described above, the cartridge holder 14 is locked (or fixed) by the cartridge holder locking mechanism 36 until the cartridge 20 is inserted therein.

In this state, it will be assumed that the cartridge 20 is manually inserted in the cartridge holder 14 along the insertion direction A. Thereby, the above-mentioned lock of the cartridge holder 14 by the cartridge holder locking mechanism 36 is released and the cartridge holder 14 is movable along the insertion direction A. In this event, inasmuch as the cartridge holder locking mechanism 36 rotates around a rotation axis thereof in a clockwise direction, the fourth switch SW4 turns on (or changes a HIGH state to a LOW state) and a cartridge normal insertion signal indicating that the cartridge 20 is correctly inserted in the cartridge holder 14 is sent to the control circuit 50 (FIG. 6).

When the cartridge 20 is perfectly inserted in the cartridge holder 14, the cartridge 20 is engaged with the cartridge holding mechanism 15.

In this state, it will be assumed that the cartridge 20 is further manually pushed in the insertion direction A. Thereby, the cartridge holder 14 is pushed in the insertion direction A. As a result, coupled to the cam slider 42, the arm housing 40 rotates around the rotation shaft 401 in the clockwise direction as illustrated in an arrow B of FIG. 7A. Thereby, coupled to the arm housing 40, the gear cam 38 rotates around the center axis thereof in the counterclockwise direction. Coupled to the gear cam 38, the mode gear 32 rotates around the center axis thereof in the clockwise direction. That is, by pushing the cartridge 20 in the insertion direction A, the mode gear 32 is driven.

When the cartridge 20 is continuously manually pushed in the insertion direction A, the above-mentioned zeroth switch SW0 (FIG. 1) turns on at a predetermined position and a cartridge insertion signal indicating that the cartridge 20 is inserted is sent to the control circuit 50 (FIG. 6). Responsive to the cartridge insertion signal, the control circuit 50 drives the mode motor 30 (FIG. 1) to rotatably drive the mode gear 32 around the center axis thereof in the clockwise direction. Thereby, coupled to the mode gear 32 via the gear cam 38, the arm housing 40, and the cam slider 42, the cartridge holder 14 moves along the insertion direction A. As a result, engaged with the cartridge holding mechanism 15, the cartridge 20 also moves along the insertion direction A and the automatic load operation of the cartridge 20 is carried out.

Referring now to FIGS. 1 and 2, the description will proceed to the guide arrangement for guiding the cartridge holder 14 and the cartridge holding mechanism 15.

The tape drive 10 comprises, as the guide arrangement, a first guide wall 46 and a second guide wall 47 both of which extend in the insertion direction A. The first guide wall 46 is called a right-hand guide wall because it is disposed in a right hand with respect to the insertion direction A. The second guide wall 47 is called a left-hand guide wall because it is disposed in a left hand with respect to the insertion direction A.

As shown in FIG. 1, the first guide wall (the right-hand guide wall) 46 has a first guide channel slot 461 for guiding the cartridge holder 14 and a second guide channel slot 462 for guiding the cartridge holding mechanism 15. The first guide channel slot 461 extends along the insertion direction A. On the other hand, the second guide channel slot 462 has an L-shape which extends along the insertion direction A and extends in a direction perpendicular to the insertion direction A toward the chassis 12. In the first guide channel slot 461, a first guide pin 141 is engaged. The first guide pin 141 projects laterally from a right-hand wall of the cartridge holder 14. In the second guide channel slot 462, a second guide pin 152 is engaged. The second guide pin 152 projects laterally from a right-hand wall of the cartridge holding mechanism 15.

As shown in FIG. 2, the second guide wall (the left-hand guide wall) 47 has a pair of third guide channel slots 473 for guiding the cartridge holder 14 and a pair of fourth guide channel slots 474 for guiding the cartridge holding mechanism 15. The pair of third guide channel slots 473 extends along the insertion direction A. On the other hand, the pair of fourth guide channel slots 474 has an L-shape which extends along the insertion direction A and extends in a direction perpendicular to the insertion direction A toward the chassis 12. In the pair of third guide channel slots 473, a pair of third guide pins 143 is engaged, respectively. The pair of third guide pins 143 projects laterally from a left-hand wall of the cartridge holder 14. In the pair of fourth guide channel slots 474, a pair of fourth guide pins 154 is engaged, respectively. The pair of fourth guide pins 154 projects laterally from a left-hand wall of the cartridge holding mechanism 15.

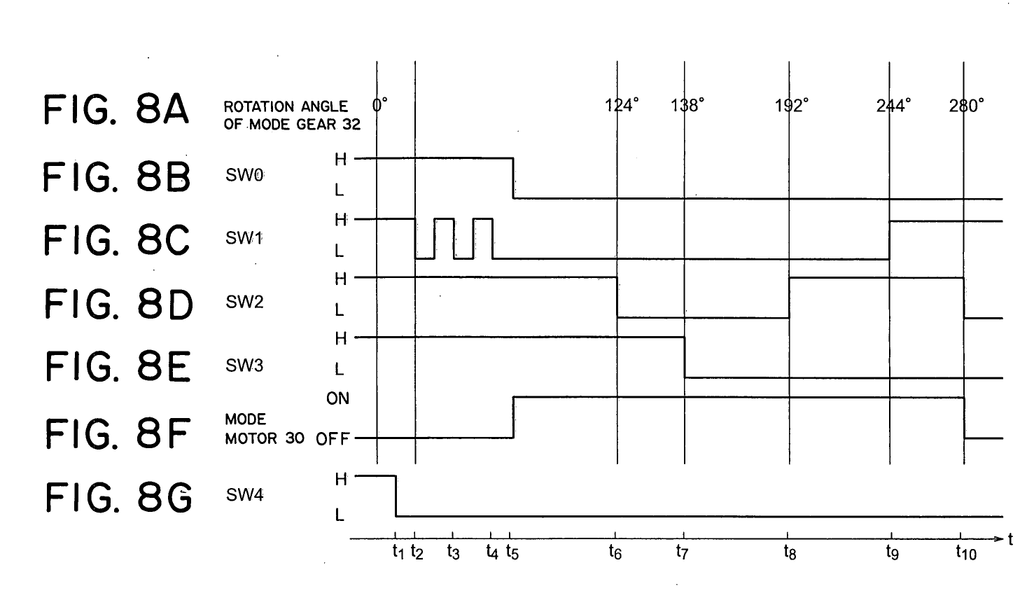

Referring now to FIGS. 8A-8G, 9, 10, and 11, the description will be made as regards operation in a case of loading the cartridge 20 in detail.

FIGS. 8A-8G show a time chart for use in describing operation in a case of loading the cartridge 20. FIG. 8A shows a rotation angle of the mode gear 32. FIGS. 8B shows a state of the zeroth switch SW0. FIG. 8C shows a state of the first switch SW1. FIG. 8D shows a state of the second switch SW2. FIG. 8E shows a state of the third switch SW3. FIG. 8F shows an ON/OFF state of the mode motor 30. FIG. 8G shows a state of the fourth switch SW4. Each of the zeroth through the fourth switches SW0 to SW4 is put into a HIGH state when it is shielded by means of the corresponding one of the zeroth through the shielding plates. Each of the zeroth through the fourth switches SW0 to SW4 is put into a LOW state when it is not shielded by means of the corresponding one of the zeroth through the shielding plates.

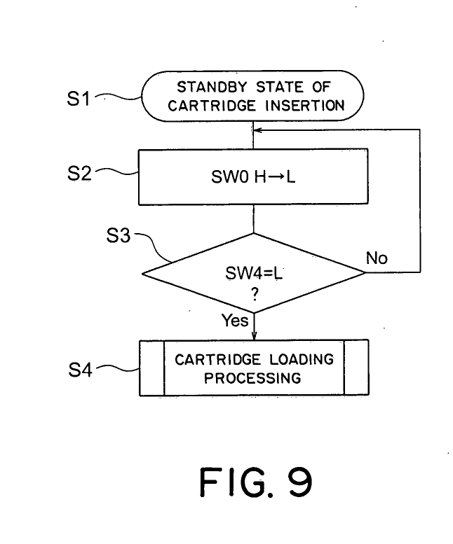

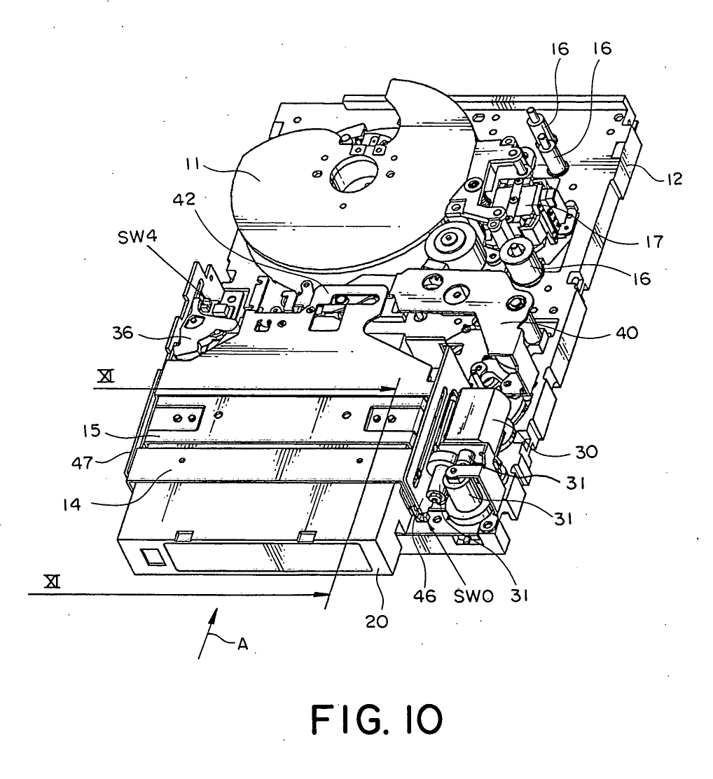

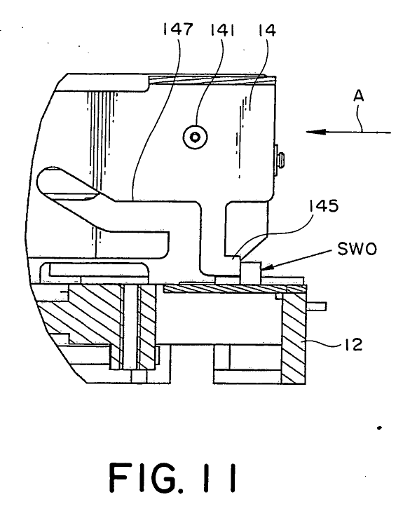

FIG. 9 is a flow chart for use in describing operation in the control circuit 50 in a case of loading the cartridge 20. FIG. 10 is a perspective view showing the tape drive 10. FIG. 11 is a cross-sectional view taken on line XI-XI of FIG. 10.

As shown in FIG. 11, the cartridge holder 14 comprises a right-hand wall having a zeroth shielding plate depicted at 145 for shielding the zeroth switch SW0. In addition, the right-hand wall of the cartridge holder 14 has a cam channel hole 147. Through the cam channel hole 147, the second guide pin 152, which projects from the right-hand wall of the cartridge holding mechanism 15, engages with the second guide channel slit 462 of the right-hand guide wall 46. Although illustration is omitted, the cartridge holder 14 comprises a left-hand wall having a pair of cam channel holes. Though the pair of cam channel holes, the pair of fourth guide pins 154, which projects from the left-hand wall of the cartridge holding mechanism 15, engages with the pair of fourth guide channel slits 474 of the left-hand guide wall 47.

At first, the control circuit 50 is put into a standby state of cartridge insertion (step Si of FIG. 9). In the standby state, as shown in FIGS. 8B, 8C, 8D, 8E, and 8G, the zeroth through the fourth switches SW0, SW1, SW2, SW3, and SW4 are shielded by means of the zeroth through the fourth shielding plates 145, 321, 322, 323, and 361. That is, all of the switches SW0 to SW4 are put into the HIGH state.

In this state, it will be assumed that the cartridge 20 is correctly manually in the cartridge holder 14 along the insertion direction A. In this event, the lock of the cartridge holder 14 by means of the cartridge holder locking mechanism 36 is released and the cartridge holder locking mechanism 36 rotates around the rotation axis thereof in a counterclockwise direction. Thereby, shielding of the fourth switch SW4 by means of the fourth shielding plate 361 is released at a time instant ti and the fourth switch SW4 changes from the HIGH state to the LOW state.

Thereafter, when the cartridge 20 is continuously manually pushed in the insertion direction A and when the cartridge 20 is perfectly inserted in the cartridge holder 14, the cartridge 20 is engaged with the cartridge holding mechanism 15.

While the cartridge 20 is furthermore pushed from this state in the insertion direction A, the cartridge holder 14 is pushed in the insertion direction A and the mode gear 32 is driven through the cam slider 42, the arm housing 40, and the gear cam 35. That is, the mode gear 32 starts to rotate around the center axis thereof in the clockwise direction.

Inasmuch as the mode gear 32 rotates and the first switch SW1 reaches a position corresponding to a trailing edge of the second slit 321c of the first shielding plate 321 at a time instant t₂, the first switch SW1 changes from the HIGH state from the LOW state. Thereafter, inasmuch as the mode gear 32 rotates and the first switch SW1 reaches a position corresponding to a leading edge of the second slit 321c of the first shielding plate SW1, the first switch SW1 is turned back to the HIGH state. Subsequently, inasmuch as the mode gear 32 rotates and the first switch SW1 reaches a position corresponding to a trailing edge of the first slit 321b of the first shielding plate 321 at a time instant t₃, the first switch SW1 changes to the LOW state again. Thereafter, inasmuch as the mode gear 32 rotates and the first switch SW1 reaches a position corresponding to a leading edge of the first slit 321b of the first shielding plate SW1, the first switch SW1 is turned back to the HIGH state. Subsequently, inasmuch as the mode gear 32 rotates and the first switch SW1 reaches a position corresponding to the one edge 321a of the first shielding plate 321 at a time instant 4, the first switch SW1 changes to the LOW state again.

While the cartridge 20 is continuously manually pushed in the insertion direction A, the zeroth switch SW0 is away from the zeroth shielding plate 145 at a time instant t₅, as shown in FIG. 11. As a result, the zeroth switch SW0 changes from the HIGH state to the LOW state (step S2 in FIG. 9). That is, the cartridge insertion signal is sent from the zeroth switch SW0 to the control circuit 50. Responsive to the cartridge insertion signal, the control circuit 50 determines whether or not the fourth switch SW4 is put into the LOW state, namely, whether or not the cartridge normal insertion signal is sent from the fourth switch SW4 (step S3 in FIG. 9). If the fourth switch SW4 is not put into the LOW state (No of the step S3), the control circuit 50 turns back processing to the step S2. Conversely, if the fourth switch SW4 is put into the LOW state (Yes in the step S3), the control circuit 50 carries out a cartridge loading processing (step S4 in FIG. 9).

Specifically, the control circuit 50 starts the mode motor 30 up to rotate the mode motor 30 and to make the mode motor 30 rotate, via the reduction gears 31, the mode gear 32 around the center axis thereof in the clockwise direction. Thereby, engaged with the mode gear 32, the gear cam 38 rotates around the center axis thereof in the counterclockwise direction. The arm housing 40 having the engagement pin 403a, which is engaged with the cam groove 381 of the gear cam 38, rotates around the rotation shaft 401 in the clockwise direction, as shown in an arrow B in FIG. 7A. The cam slider 42 having the slider slit 421, in which the engagement pin 402a of the arm housing 40 is inserted, shits or moves in the insertion direction A. Thereby, formed integrally to the cam slider 42, the cartridge holder 14 also shifts or moves in the insertion direction A and the cartridge 20 engaged with the cartridge holding mechanism 15 shifts or moves in the insertion direction A. In the manner which is described above, the automatic load operation is carried out.

Inasmuch as the mode gear 32 continuously rotates in the clockwise direction by driving the mode motor 30, the second switch SW2 reaches a position corresponding to the edge 322a of the second shielding plate 322 at a time instant t₆. This time instant (position) corresponds to a position where the mode gear 32 has the rotation angle of 124° and the second switch SW2 changes from the HIGH state to the LOW state. That is, the cleaning position detected signal is sent from the second switch SW2 to the control circuit 50. At this position, cleaning of the magnetic head 17a is carried out in the manner which is known in the art.

While the mode gear 32 continuously rotates in the clockwise direction by driving the mode motor 30, at a time instant t₇, the third switch SW3 reaches a position corresponding to an edge 323a of the third shielding plate 323. This time instant (position) corresponds to a position where the mode gear 32 has the rotation angle of 138° and the third switch SW3 changes from the HIGH state to the LOW state. That is, the cartridge chucking position detected signal is sent from the third switch SW3 to the control circuit 50. At this position, chucking operation of the cartridge is carried out in the manner which is known in the art.

While the mode gear 32 continuously rotates in the clockwise direction by driving the mode motor 30, at a time instant t₈, the second switch SW2 reaches a position corresponding to another edge 322b of the second shielding plate 322. This time instant (position) correspond to a position where the mode gear 32 had the rotation angle of 192° and the second switch SW2 changes from the LOW state to the HIGH state. That is, the grabber hooking position detected signal is sent from the second switch SW2 to the control circuit 50. At this position, hooking operation of the grabber is carried out in the manner which is known in the art.

While the mode gear 32 continuously rotates in the clockwise direction by driving the mode motor 30, at a time instant t₈, the first switch SW1 reaches a position corresponding to another edge 321d of the first shielding plate 321. This time instant (position) corresponds to a position where the mode gear 32 has the rotation angle of 244° and the first switch SW1 changes from the LOW state to the HIGH state. That is, the leader pin checking position detected signal is sent from the first switch SW1 to the control circuit 50. Responsive to the leader pin checking position detected signal, the control circuit 50 checks whether or not the grabber securely hooks the leader pin thereon in the manner which is known in the art.

While the mode gear 32 continuously rotates in the clockwise direction by driving the mode motor 30, at a time instant t₁₀, the second switch SW2 reaches a position corresponding to still another edge 322c of the second shielding plate 322. This time instant (position) correspond to a position where the mode gear 32 has the rotation angle of 280° and the second switch SW2 changes from the HIGH state to the LOW state. That is, the grabber releasing position detected signal is sent from the second switch SW2 to the control circuit 50. AT this position, releasing operation of the grabber is carried out in the manner which is known in the art. In addition, in response to the grabber releasing position detected signal, the control circuit 50 stops the driving of the mode motor 30.

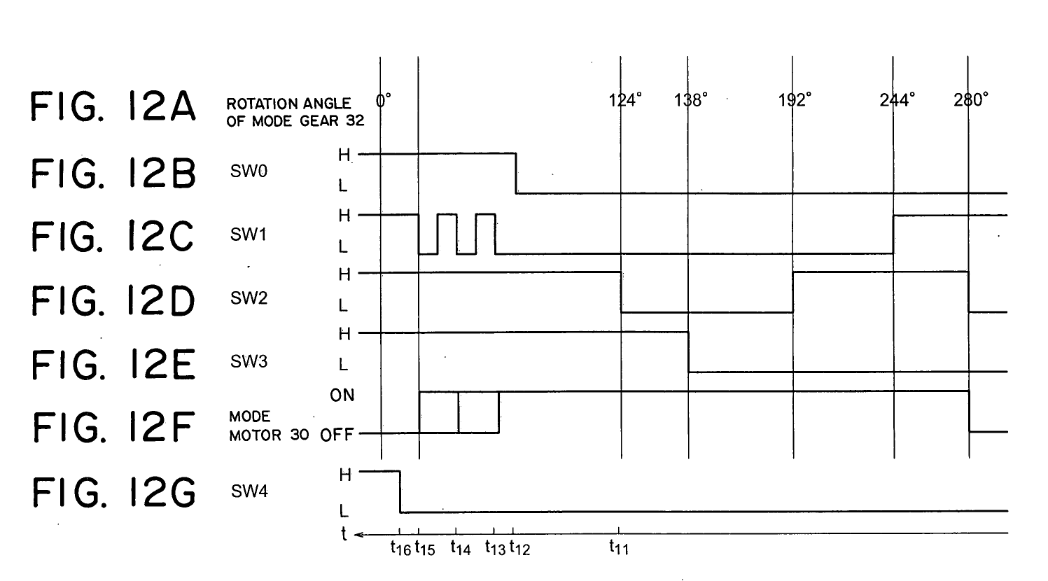

Referring now to FIGS. 12A-12G, 13 to 18, the description will be made as regards operation in a case of electing the cartridge 20 in detail.

FIGS. 12A-12G show a time chart for use in describing operation in a case of ejecting the cartridge 20. FIG. 12A shows a rotation angle of the mode gear 32. FIG. 12B shows a state of the zeroth switch SW0. FIG. 12C shows a state of the first switch SW1. FIG. 12D shows a state of the second switch SW2. FIG. 12E shows a state of the third switch SW3. FIG. 12F shows an ON/OFF state of the mode motor 30. FIG. 12G shows a state of the fourth switch SW4. Each of the zeroth through the fourth switches SW0 to SW4 is put into a HIGH state when it is shielded by means of the corresponding one of the zeroth through the shielding plates. Each of the zeroth through the fourth switches SW0 to SW4 is put into a LOW state when it is not shielded by means of the corresponding one of the zeroth through the shielding plates.

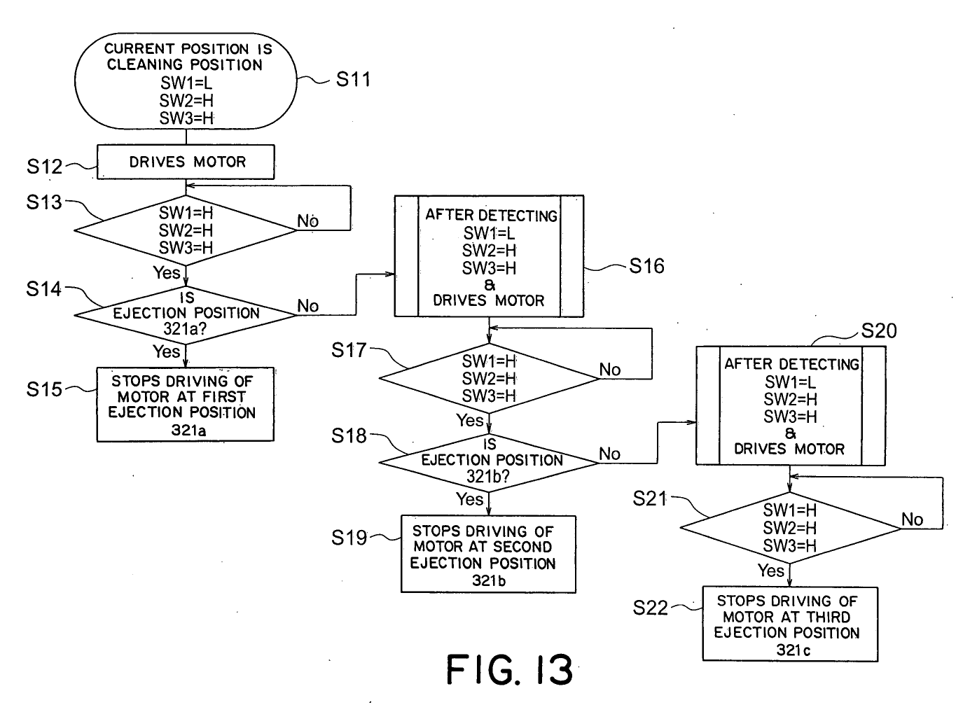

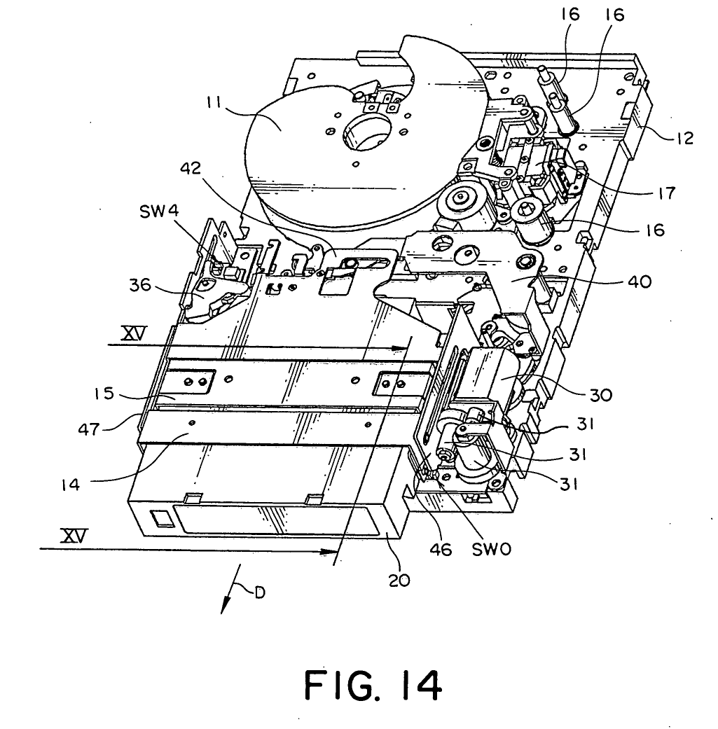

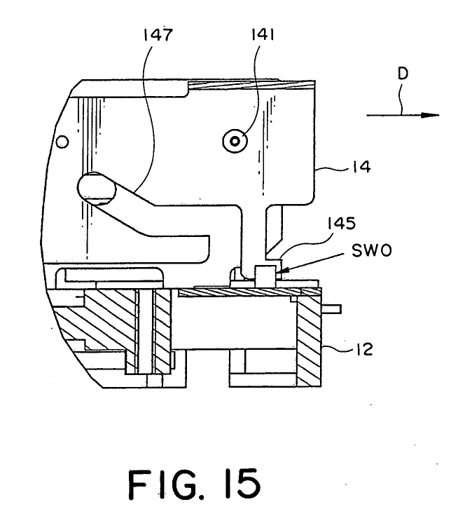

FIG. 13 is a flow chart for use in describing operation in the control circuit 50 in a case of ejecting the cartridge 20. FIG. 14 is a perspective view showing the tape drive 10. FIG. 15 is a cross-sectional view taken on line XV-XV of FIG. 14.

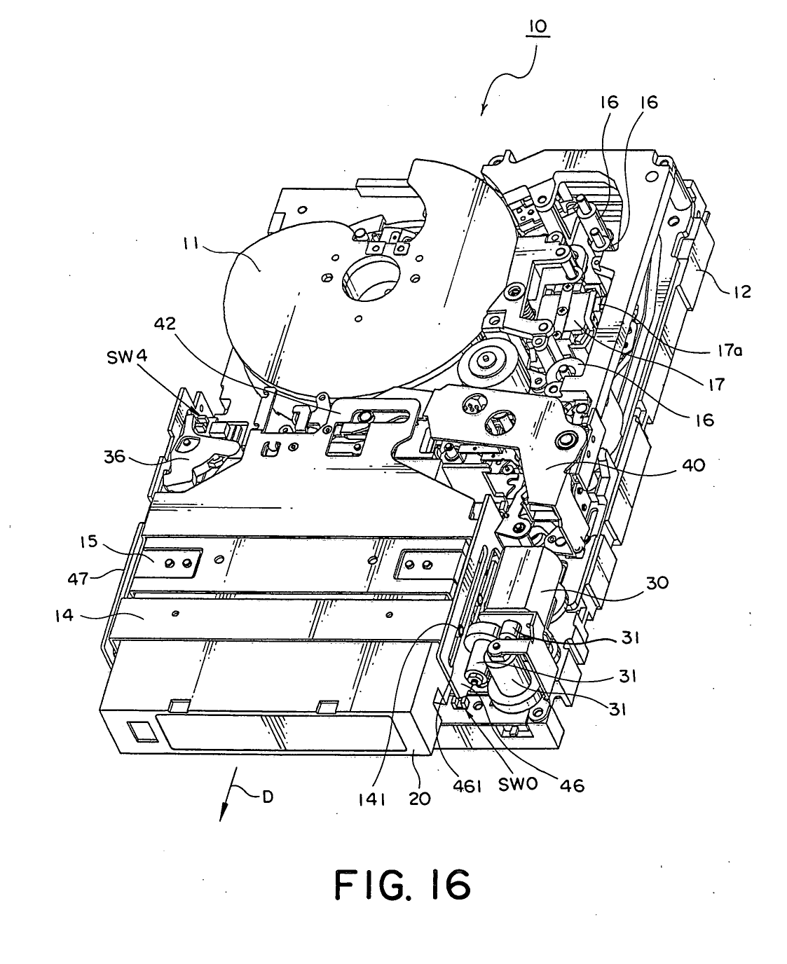

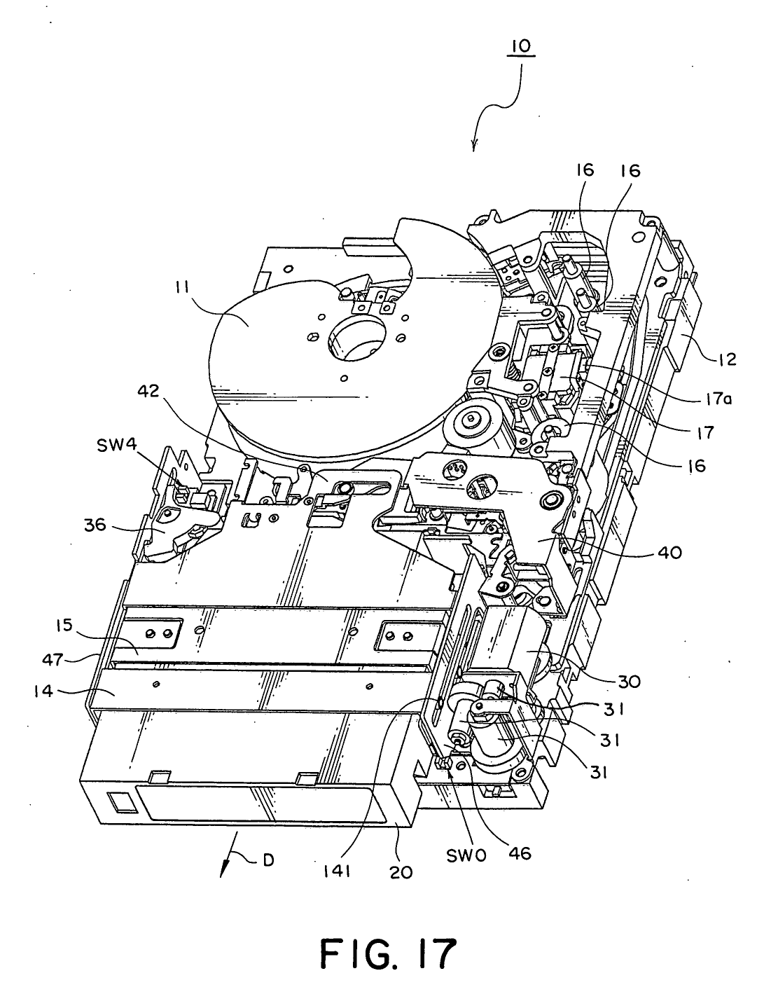

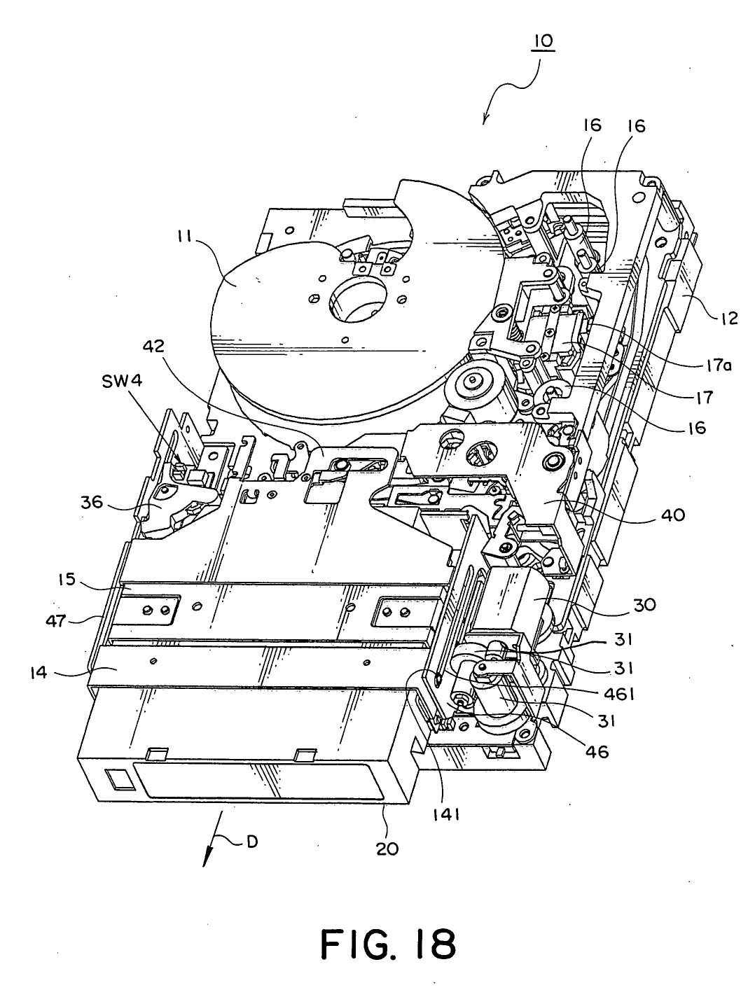

FIG. 16 is a perspective view showing the tape drive 10 in a state where the cartridge 20 is stopped when the first switch SW1 reaches a position corresponding to the one edge 321a of the first shielding plate 321. FIG. 17 is a perspective view showing the tape drive 10 in a state where the cartridge 20 is stopped when the first switch SW1 reaches a position corresponding to the trailing edge of the first slit 321b of the first shielding plate 321. FIG. 18 is a perspective view showing the tape drive 10 in a state where the cartridge 20 is stopped when the first switch SW1 reaches a position corresponding to the trailing edge of the second slit 321c of the first shielding plate 321.

At first, it will be assumed that a current position at a time instant t₁₁ corresponds to a cleaning position where the mode gear 32 has the rotation angle of 124° (step S11 in FIG. 13). In this state, the zeroth switch SW0 is put into the LOW state as shown in FIG. 12B, the first switch SW1 is put into the LOW state as shown in FIG. 12C, the second switch SW2 is put into the HIGH state as shown in FIG. 12D, the third switch SW3 is put into the HIGH state as shown in FIG. 12E, and the fourth switch SW4 is put into the LOW state as shown in FIG. 12G.

It will be assumed that, at the time instant tea, an ejection command is issued or an ejection button is pushed. When this event is detected by the control circuit 50, the control circuit 50 drives the mode motor 30 (step S12 in FIG. 13) to make the mode motor 30 rotate the mode gear 32 around the center axis thereof in the counterclockwise direction. Thereby, engaged with the mode gear 32, the gear cam 38 rotates around the center axis thereof in the clockwise direction. As a result, the arm housing 40 having the engagement pin 403a, which engages in the cam groove 381 of the gear cam 38, rotates around the rotation shaft 401 in the counterclockwise direction as shown in an arrow C in FIG. 7B. The cam slider 42 having the slider slit 421, in which the engagement pin 402a of the arm housing 40 is inserted, shifts or moves in a pulling-out direction (an ejection direction) as shown in an arrow D in FIG. 7b. Thereby, inasmuch as the cartridge holder 40, which is integrally formed to the cam slider 42, shifts or moves in the pulling-out direction (the ejection direction) D, engaged with the cartridge holding mechanism 15, the cartridge 20 also shifts or moves in the pulling-out direction (the ejection direction) D. In the manner which is described above, an ejection operation of the cartridge 20 starts.

Inasmuch as the cartridge holder 14 shifts or moves in the pulling-out direction (the ejection direction) D, at a time instant t₁₂, the zeroth shielding plate 145 shields the zeroth switch SW0 as shown in FIG. 15. As a result, the zeroth switch SW0 changes from the LOW state to the HIGH state.

While the mode gear 32 continuously rotates in the counterclockwise direction by driving the mode motor 30, at a time instant t₁₃, the first switch SW1 reaches a position corresponding to the edge 321a of the fist shielding plate 321. As a result, the first switch SW1 changes from the LOW state to the HIGH state. That is, a first ejection position detected signal is sent from the first switch SW1 to the control circuit 50. Therefore, the control circuit 50 detects that all of the first through the third switches SW1 to SW3 are put into the HIGH state (Yes in step S13 in FIG. 13). Responsive to the first ejection position detected signal, the control circuit 50 determines whether or not the ejection position where the cartridge 20 should be stopped is a first ejection position where the first switch SW1 detects the edge 321a of the first shielding plate 321 (step S14 in FIG. 13). If that is the case (Yes of the step S14), the control circuit 50 stops the driving of the mode motor 30 (step S15 in FIG. 13). The state where the driving of the mode motor 30 is stopped at the first ejection position is illustrated in FIG. 16.

On the other hand, it will be assumed that the ejection position where the cartridge 20 should be stopped is not the first ejection position where the first switch SW1 detects the edge 321a of the first shielding plate 321 (No of the step S14). In this event, inasmuch as the control circuit 50 continuously drives the mode motor 30 and the mode gear 32 rotates in the counterclockwise direction, the first switch SW1 reaches a position corresponding to the leading edge of the first slit 321b of the first shielding plate 321. As a result, the first switch SW1 is turned from the HIGH state back to the LOW state. Thereby, the control circuit 50 detects that the first through the third switches SW1 to SW3 are put into the LOW state, the HIGH state, and the HIGH state, respectively (step S16 in FIG. 13).

While the control circuit 50 continuously drives the mode motor 30 to continuously rotate the mode gear 32 in the counterclockwise direction, at a time instant t₁₄, the first switch SW1 reaches a position corresponding to the trailing edge of the first slit 321b of the first shielding plate 321. As a result, the first switch SW1 changes from the LOW state to the HIGH state. That is, a second ejection position detected signal is sent from the first switch SW1 to the control circuit 50. Therefore, the control circuit 50 detects that all of the first through the third switches SW1 to SW3 are put into the HIGH state (Yes in step S17 in FIG. 13). Responsive to the second ejection position detected signal, the control circuit 50 determines whether or not the ejection position where the cartridge 20 should be stopped is a second ejection position where the first switch SW1 detects the trailing edge of the first slit 321b of the first shielding plate 321 (step S18 in FIG. 13). If that is the case (Yes of the step S18), the control circuit 50 stops the driving of the mode motor 30 (step S19 in FIG. 13). The state where the driving of the mode motor 30 is stopped at the second ejection position is illustrated in FIG. 17.

On the other hand, it will be assumed that the ejection position where the cartridge 20 should be stopped is not the second ejection position where the first switch SW1 detects the trailing edge of the first slit 321b of the first shielding plate 321 (No of the step S18). In this event, inasmuch as the control circuit 50 continuously drives the mode motor 30 and the mode gear 32 rotates in the counterclockwise direction, the first switch SW1 reaches a position corresponding to the leading edge of the second slit 321c of the first shielding plate 321. As a result, the first switch SW1 is turned from the HIGH state back to the LOW state. Thereby, the control circuit 50 detects that the first through the third switches SW1 to SW3 are put into the LOW state, the HIGH state, and the HIGH state, respectively (step S20 in FIG. 13).

While the control circuit 50 continuously drives the mode motor 30 to continuously rotate the mode gear 32 in the counterclockwise direction, at a time instant t₁₅, the first switch SW1 reaches a position corresponding to the trailing edge of the second slit 321c of the first shielding plate 321. As a result, the first switch SW1 changes from the LOW state to the HIGH state. That is, a third ejection position detected signal is sent from the first switch SW1 to the control circuit 50. Therefore, the control circuit 50 detects that all of the first through the third switches SW1 to SW3 are put into the HIGH state (Yes in step S21 in FIG. 13). In this event, the control circuit 50 sets the ejection position where the cartridge 20 should be stopped in a third ejection position where the first switch SW1 detects the trailing edge of the second slit 321b of the first shielding plate 321. Accordingly, responsive to the third ejection position detected signal, the control circuit 50 stops the driving of the mode motor 30 (step S22 in FIG. 13). The state where the driving of the mode motor 30 is stopped at the third ejection position is illustrated in FIG. 18.

When the cartridge 20 is manually pulled out from this state in the pulling-out direction (the ejection direction) D, the cartridge holder locking mechanism 36 rotates around the rotation axis thereof in the clockwise direction to lock the cartridge holder 14. In this event, at a time instant t₁₆, inasmuch as the fourth switch SW4 is shielded by the fourth shielding plate 361, the fourth switch SW4 changes from the LOW state to the HIGH state.

In the manner which is described above, according to this embodiment, it is possible on ejecting the cartridge 20 to select the election position (the election amount) at which the cartridge 20 should be stopped from the first through the third ejection positions by rewriting firmware. In other words, inasmuch as the ejection amount of the cartridge 20 can be adjusted by stopping the driving of the mode motor 30 at any of the time instants t₁₃, t₁₄, and t₁₅ where the first switch SW1 changes from the LOW state to the HIGH state, it is possible to change the cartridge's projection amount (the election amount) in a software fashion.

By adopting such an ejection amount adjustment mechanism, it is unnecessary to replace parts to be used for each autoloader maker. That is, the ejection amount adjustment mechanism is advantageous in that it is possible to make the tale drive 10 completely manufactured by using the same parts be compatible with a plurality of ejection amounts by rewriting firmware. In this embodiment, inasmuch as at least one slit is formed in the first shielding plate 321 of the mode gear 32 to implement the ejection amount adjustment mechanism, it is unnecessary to add a particular part and it results in cost advantage. Furthermore, by taking possession of the firmware in an end user from a medium such as the Internet to update the firmware, it is possible to be at liberty to change the cartridge's projection amount (the ejection amount).

While this invention has thus far been described in conjunction with a preferred embodiment thereof, it is to be understood that modifications will be apparent to those skilled in the art without departing from the spirit of the invention. For example, although, as the position sensor for detecting the ejection positions, an optical position sensor comprising a combination of the arc-shaped shielding plate having at least one slit and the photo-interrupter is used in the above-mentioned embodiment, the position sensor is not restricted to the optical position sensor having such a structure. For example, as the position sensor, a magnetic position sensor or a mechanical position sensor may be used in lieu of the optical position sensor. The magnetic position sensor may comprise a combination of an arc-shaped plate provided with a plurality of permanent magnets at positions corresponding to the plurality of ejection positions and a Hall sensor. The mechanical position sensor may comprise a combination of an arc-shaped plate provided with a plurality of projections and/or concave portions at positions corresponding to the plurality of ejection positions and a mechanical switch.

What is claimed is:

1. A recording and/or reproducing device comprising an ejection mechanism for ejecting a cartridge accommodated in said recording and/or reproducing device out of said recording and/or reproduction device by coming into contact with said cartridge, wherein said ejection mechanism comprises an ejection amount adjustment mechanism for adjusting an ejection amount of said cartridge by rewriting firmware without replacing any part.

2. The recording and/or reproducing device as claimed in claim 1, wherein said ejection mechanism comprises a mode motor, a mode gear driven by said mode motor, and a cartridge holder, coupled to said mode gear, for holding said cartridge,
wherein said ejection amount adjustment mechanism comprises:
an arc-shaped plate, attached to said mode gear, having a plurality of detected elements provided at positions corresponding to a plurality of ejection positions of said cartridge;
a detection arrangement, disposed near to said arc-shaped plate, for detecting the plurality of detected elements to produce a plurality of detected signals; and
a control circuit for stopping driving of said mode motor on the basis of one selected from the plurality of detected signals.

3. The recording and/or reproducing device as claimed in claim 2, wherein said arc-shaped plate comprises a shielding plate, said plurality of detected elements comprising an edge of said shielding plate and at least one slit formed on said shielding plate, said detecting arrangement comprising a photo-interrupter.

4. An ejection mechanism for ejecting a cartridge accommodated in a recording and/or reproducing device out of said recording and/or reproduction device by coming into contact with said cartridge, wherein said ejection mechanism comprises an ejection amount adjustment mechanism for adjusting an ejection amount of said cartridge by rewriting firmware without replacing any part.

5. The ejection mechanism as claimed in claim 4, wherein said ejection mechanism comprises a mode motor, a mode gear driven by said mode motor, and a cartridge holder, coupled to said mode gear, for holding said cartridge,
wherein said ejection amount adjustment mechanism comprises:
an arc-shaped plate, attached to said mode gear, having a plurality of detected elements provided at positions corresponding to a plurality of ejection positions of said cartridge;
a detection arrangement, disposed near to said arc-shaped plate, for detecting the plurality of detected elements to produce a plurality of detected signals; and
a control circuit for stopping driving of said mode motor on the basis of one selected from the plurality of detected signals.

6. The ejection mechanism as claimed in claim 5, wherein said arc-shaped plate comprises a shielding plate, said plurality of detected elements comprising an edge of said shielding plate and at least one slit formed on said shielding plate, said detecting arrangement comprising a photo-interrupter.

7. An ejection amount adjustment mechanism provided in an ejection mechanism for ejecting a cartridge accommodated in a recording and/or reproducing device out of said recording and/or reproduction device by coming into contact with said cartridge, said ejection amount adjustment mechanism being for adjusting an ejection amount of said cartridge, wherein said ejection amount adjustment mechanism adjusts the ejection amount by rewriting firmware without replacing any part.

8. The ejection amount adjustment mechanism as claimed in claim 7, wherein said ejection mechanism comprises a mode motor, a mode gear driven by said mode motor, and a cartridge holder, coupled to said mode gear, for holding said cartridge,
wherein said ejection amount adjustment mechanism comprises:
an arc-shaped plate, attached to said mode gear, having a plurality of detected elements provided at positions corresponding to a plurality of ejection positions of said cartridge;
a detection arrangement, disposed near to said arc-shaped plate, for detecting the plurality of detected elements to produce a plurality of detected signals; and
a control circuit for stopping driving of said mode motor on the basis of one selected from the plurality of detected signals.

9. The ejection amount adjustment mechanism as claimed in claim 8, wherein said arc-shaped plate comprises a shielding plate, said plurality of detected elements comprising an edge of said shielding plate and at least one slit formed on said shielding plate, said detecting arrangement comprising a photo-interrupter.

10. An ejection position detection mechanism for use in an ejection mechanism for ejecting a cartridge accommodated in a recording and/or reproducing device out of said recording and/or reproduction device by coming into contact with said cartridge, said ejection position detection mechanism being for detecting an ejection position of said cartridge, said ejection mechanism comprising a mode motor, a mode gear driven by said mode motor, and a cartridge holder, coupled to said mode gear, for holding said cartridge, wherein said ejection position detection mechanism comprises:
an arc-shaped plate, attached to said mode gear, having a plurality of detected elements provided at positions corresponding to a plurality of ejection positions of said cartridge; and
a detection arrangement, disposed near to said arc-shaped plate, for detecting the plurality of detected elements.

11. The ejection position detection mechanism as claimed in claim 10, wherein said arc-shaped plate comprises a shielding plate, said plurality of detected elements comprising an edge of said shielding plate and at least one slit formed on said shielding plate, said detecting arrangement comprising a photo-interrupter.
